(19) United States
(12) Patent Application Publication
(10) Pub. No.: US 2009/0090551 A1
(43) Pub. Date: Apr. 9, 2009

(54) Modular multi-channel snake connector

(76) Inventors: Robert J. Cunningham, Levittown, NY (US); Robert D'Addario, Williston Park, NY (US)

Correspondence Address: ALIX YALE & RISTAS LLP, 750 MAIN STREET, SUITE 1400, HARTFORD, CT, 06103, US

(21) Appl. No.: 11/906,626

(22) Filed: Oct. 3, 2007

(51) Int. Cl. H01R 31/06; H01B 7/04

(52) U.S. Cl. 174/72 A; 174/74 R; 439/638

(57) ABSTRACT

A snake electrical connector comprising a central snake cable having a plurality of conductors terminating at a base connector at each end of the snake cable. Each of the base connectors has a respective plurality of individual electrical contacts corresponding to each conductor. A fan-out is provided at each end of the snake cable, each fan-out having a connector conductively mated with the contacts in the base connector of the snake cable, and a plurality of cables extending therefrom with an end connector at the distal end of each cable. A latching mechanism is provided for selectively attaching and detaching the connector of a fan-out to a base connector of said snake cable. The connector may be provided as a kit wherein a plurality of fan-outs is included at least some of which have a different array of connectors at their distal ends.

### TECHNICAL FIELD

This invention relates generally to audio/visual cable assembles and, more particularly, to a modular multi-channel snake connector for providing multiple connections between a plurality of different audio/visual devices.

### BACKGROUND

There are a multitude of different types of electrical devices used in the musical world. For example, bands utilize microphones, speakers, amplifiers and various types of electronic instruments. Music stores need to display amplifiers, speakers, various recording equipment and stereos and demonstrate them to potential customers. These devices must be electrically interconnected in various combinations and use a variety of different types of electrical connectors such as XLR (male and female), stereo, TRS, RCA or other type connectors.

In the day to day operation of bands and music stores, there is a need for a constant setup and breakdown of various combinations of these electrical components. Additionally, some components which are required to be electrically interconnected are spaced quite a distance from each other. Utilizing a separate connector for each type of connection results in a plurality of long cables strung throughout the location, as well as requiring keeping track of the ends of each of the long cables to determine which connector is connected to which jack.

It is known to provide a long length of cable, or snake, which has a fan-out at each end for connecting audio/video components. An example of such arrangement is shown in U.S. Pat. No. 5,792,986 which shows a cable management system wherein a central cable snake has fan-outs associated with a pod at one end and fan-outs associated with a pod at another end. In one embodiment shown in the patent, a plurality of individual cables is connected to the pod at one end and to their respective input or output device at the other end. While such device helps eliminate the need of a plurality of both these cables extending between the input and output devices, it still requires a plurality of individual cables for connection between the pod and its respective input/output device to accommodate different types of connectors.

Accordingly, there is a need for a simplified modular multi-channel snake which can handle different type connectors and use it in an efficient manner.

### SUMMARY

In accordance with one aspect illustrated herein there is provided a modular snake electrical connector kit comprising a central snake cable having a base connector at each end. A plurality of fan-outs each has a connector adapted to be connected to either of the base connectors of the central snake cable. The fan-outs include a plurality of cables extending therefrom with an end connector at the distal end of each cable. The kit contains at least three fan-outs, each having a different array of end connectors.

Another aspect is directed to a snake electrical connector comprising a central snake cable having a plurality of conductors terminating at a base connector at each end of the snake cable, each base connector having a respective plurality of individual electrical contacts corresponding to each conductor. A fan out is located at each end of the snake cable, each fan out having a connector conductively mated with the contacts in the base connector of the snake cable, and a plurality of cables extending therefrom with an end connector at the distal end of each cable. A latching mechanism selectively attaches and detaches the connector of a fan-out to a base connector of the snake cable.

### BRIEF DESCRIPTION OF THE DRAWINGS

FIG. 1 is a plan view of the snake cable and fan-outs shown in one type of connector at the input end and a separate set of connectors at the output end;

FIG. 2 is a view of the modular cable assembly of FIG. 1 with the connector slightly rotated;

FIG. 3 is a plan view of a fan-out that an be used with the snake cable of FIG. 1, but showing a set of connectors of a different type at the end of the cables of the fan-out than those shown in connection with the fan-outs of FIGS. 1 and 2; and

FIG. 4 is a plan view of a fan-out that an be used with the snake cable of FIG. 1, but showing a set of connectors of still different type at the end of the cables of the fan-out than those shown in connection with the fan-outs of the previous Figures.

### DETAILED DESCRIPTION

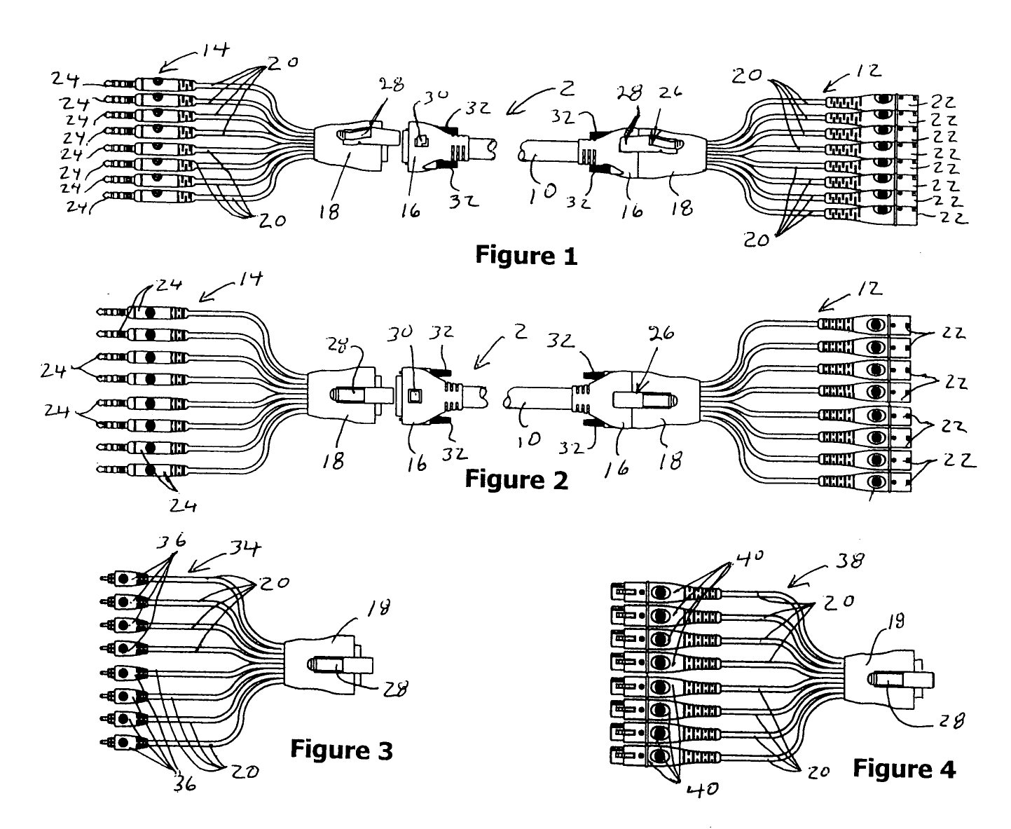

Referring to the drawings and in particular FIG. 1, there is shown a modular snake connector assembly 2 which generally comprises a central snake cable 10 having a plurality of internal conductors (such as eight), a first fan-out assembly 12 at one end thereof and a second fan-out assembly 14 at the other end. The central snake cable 10 may be of varying lengths such as 5, 10, 25, or 50 foot lengths. The central snake cable 10 has a male base connector 16 at each end respectively as shown, whereby the fan outs are conductively engaged with the individual conductors in the snake. These base connectors 16 are identical and may be of the type known as DB25 connectors, although other types of suitable connectors may be used.

The fan-outs 12 and 14 that are connected to each end of the central cable snake 10 may be of various types. One such fan-out 12 shown at the right in FIG. 1 may comprise a female connector 18 of the DB25 type adapted to mate with the male base connector 16 at the end of the cable. Alternatively, the base connector of snake 10 may be female and the connector 18 on the fan-outs may be a male. In the present example the fan-out 12 has eight cables 20 extending from the connector 18, the distal end of each one being provided with a male XLR connector 22.

The fan-out 14 shown on the left side of FIG. 1 includes a DB25 female connector 18 adapted to be attached to its respective male DB25 base connector 16 at the end of the central snake cable 10. The fan-out 14 includes eight cables 20 as in the case of the fan-out 12. However, the distal end of each of the cables 20 in this case has a ¼ inch stereo connector 24 connected thereto.

A latching mechanism 26 may be provided between the connectors 18 of each of the fan-outs 12 and 14 and the connectors 16 at the ends of the snake cable 10 to secure the connectors 16 and 18 together. The latching mechanism 26 may include a latch member 28 on the fan-out connector 18 that is adapted to a engage a tab 30 on the base connector 16 of the central snake cable 10 when the two connectors 16 and 18 are inserted into each other to secure the female fan-out connector 18 to the male central snake cable connector 16. If desired, the DB25 male connectors 16 on the central snake cable 10 may be provided with screws 32 which are adapted to be threaded into a threaded bore (not shown) in the female connector 18 of the fan-outs 12 and 14 and tightened to further secure the two connectors 16 and 18 together.

In order to make the modular snake connector 2 more universal, a plurality of fan-outs with different distal end connectors may be provided with a cable 10 as a kit. As the fan-outs are connected to the central snake cable by releasable connectors, the changing of the fan-outs to enable the cable 10 to be used with a different device is a relatively easy task.

FIG. 3 shows another fan-out 34 having different distal connectors or plugs 36 than those of the fan-outs previously described. The fan-out includes a DB25 female connector 18 with a latch member 30 as in the case of the fan-outs of FIGS. 1 and 2 that enables it to be used at either end of the central snake cable 10. The fan-out 34 also includes eight individual cables 20 extending from the female fan-out connector 18. However in this embodiment of the fan-out, the connectors 36 at the distal ends of the cables 20 are RCA male connectors.

FIG. 4 shows another fan-out arrangement 38. Like the other fan-outs the fan-out 38 includes a DB25 female connector 18 having a latch member 28 thereon. The fan-out 38 also include eight cables extending form the connector 18 each having a connector or plug 40 at its distal end. However, in the case of this embodiment, the connectors 40 at the distal end of the cable are male XLR connectors.

In view of the fact that each of the fan-outs 12, 14, 34 and 38 has the same type of connector 18 which is adapted to mate with the base connector 16 on either end of the central snake cable, any one of the above-described fan-outs may be attached to the cable. Accordingly, with this arrangement it is possible to provide a kit comprised of a single central snake cable and a plurality of fan-outs. To provide for desired flexibility, the kit should have at least three different fan-outs, although a greater number may be included, all having a different array of distal connectors. Additionally, an individual fan-out may comprise two or more different types of connectors at the distal ends of the cable. For example, a fan-out may comprise four stereo connectors and four RCA male connectors. Ideally, the length of the cables from the female connector to the various plug connectors at the distal end of the cable should be at least 18 inches to provide flexibility.

In addition to the various types of distal connectors shown at the end of the cables in the figures, a fan-out could include four XLR male and four XLR female connectors at the end of the cables as well as eight ¼ inch TRS bantam male connectors and the use of a single ELCO connector for use with ADAT connections.

With the above arrangement, when the need arises a user can easily change the various components which are interconnected together without having to use another snake even though one of the new components requires a different type of connector. This results in the user requiring less individual cables to satisfy most needs.

While various embodiments have been shown and described, various modifications and substitutions may be made thereto. Accordingly, it is understood that the present embodiments have been described by way of illustration and not limitation.

1. A modular snake electrical connector kit comprising:
a central snake cable having a base connector at each end;
a plurality of fan-outs each having a connector adapted to be connected to either of the base connectors of the central snake cable, said fan-outs having a plurality of cables extending therefrom with an end connector at the distal end of each cable, said kit containing at least three fan-outs, each having a different array of end connectors.

2. The connector kit of claim 1 further including a latching mechanism for securing the connector of a fan-out to a base connector of said central snake cable.

3. The connector kit of claim 2 wherein one of either said snake cable base connector or said fan-out connector has a latch member and the other connector has a tab to be engaged by said latch member to secure the two connectors together.

4. The connector kit of claim 1 wherein said snake cable has the same type of base connector at each end, and each of said fan-outs has a connector adapted to mate with the base connectors on said snake cable.

5. The connector kit of claim 1 wherein said connectors on one of either said snake cable or said fan-outs is a DB25 male connector and said connector on the other of said snake cable or said fan-outs is a DB25 female connector.

6. The connector kit of claim 5 wherein said base connector at each end of said snake cable is a DB25 male connector.

7. The connector kit of claim 1 wherein at least one of said fan-outs includes a ¼ inch stereo connector at the end of each of its cables and another of said fan-outs includes a male XLR connector at the end of each of its cables.

8. The connector kit of claim 1 wherein at least one of said fan-outs includes female XLR connectors at the end of each of its cables and another of said fan-out includes an RCA male connector at the end of each of its cables.

9. The connector kit of claim 1 wherein at least one of said fan-outs includes an array of different connectors at the end of its cables.

10. The connector kit of claim 1 wherein said fan-outs include eight cables each having a connector at their distal end.

11. A snake electrical connector comprising:
a central snake cable having a plurality of conductors terminating at a base connector at each end of the snake cable, each said base connector having a respective plurality of individual electrical contacts corresponding to each conductor;
a fan out at each end of the snake cable, each fan out having a connector conductively mated with the contacts in the base connector of the snake cable, and a plurality of cables extending therefrom with an end connector at the distal end of each cable; and
a latching mechanism for selectively attaching and detaching the connector of a fan-out to a base connector of said snake cable.

12. The snake connector of claim 11 wherein one of either said snake cable connector or said fan-out connector has a latch member and the other connector has a tab to be engaged by said latch member to selectively attaching the two connectors together.

13. The snake connector of claim 11 wherein said snake cable has the same type of base connector at each end, and each of said fan-outs has a connector adapted to mate with the base connectors.

14. The snake connector of claim 11 wherein said connectors on one of either said snake cable or said fan-outs is a DB25 male connector and said connector on the other of said snake cable or said fan-outs is a DB25 female connector.

15. The snake connector of claim 14 wherein said base connector at each end of said snake cable is a DB25 male connector.

16. The snake connector of claim 11 wherein at least one of said fan-outs includes a ¼ inch stereo connector at the end of each of its cables and another of said fan-outs includes a male XLR connector at the end of each of its cables.

17. The snake connector of claim 11 wherein at least one of said fan-outs includes female XLR connectors at the end of each of its cables and another of said fan-out includes an RCA male connector at the end of each of its cables.

18. The snake connector of claim 11 wherein at least one of said fan-outs includes an array of different connectors at the end of its cables.

19. The snake connector of claim 11 wherein said fan-outs include eight cables each having a connector at their distal end.

20. An electrical fan-out for removable connection to the base connector of a snake cable comprising:
a connector for removable connection to the base connector of said snake cable;
a plurality of cables extending from said connector; and
an end connector attached to the distal end of each of said cables

21. The fan-out of claim 20 wherein said connector includes means for latching with said base connector.

22. The fan-out of claim 20 wherein at least some of the connectors at the distal end of said cables are of a different type.
